(19) United States
(12) Patent Application Publication
(10) Pub. No.: US 2009/0165316 A1
(43) Pub. Date: Jul. 2, 2009

(54) Measurement Apparatus Having Display Device

(75) Inventors: SHAN-NAN CHEN, Hsin-Chu (TW); KEE-WENG LAI, Hsin-Chu (TW)

Correspondence Address: WPAT, PC, 7225 BEVERLY ST., ANNANDALE, VA, 22003, US

(73) Assignee: GRENERGY OPTO, INC., Hsinchu (TW)

(21) Appl. No.: 11/965,632

(22) Filed: Dec. 27, 2007

(51) Int. Cl. B43L 7/00; G09G 5/00

(52) U.S. Cl. 33/494; 345/660

(57) ABSTRACT

The present invention discloses a measurement apparatus having a display device. The measurement apparatus comprises a control unit, a microprocessing circuit, a display device, and a power supply unit. The control unit is used to change the measurement unit in order to measure different lengths. The measurement apparatus having a display device further comprises a calculating device to provide calculation functionality.

### BACKGROUND OF THE INVENTION

1. Field of the Invention

The present invention is generally related to a measurement apparatus, and more particularly to a measurement apparatus having a display device.

2. Description of the Prior Art

In the past, the most convenient length measurement apparatus is called “ruler”, used to measure lengths as well as draw lines, as shown in FIG. 1. A ruler usually has a scale thereon in order to measure lengths and some may have special shaped holes like alphabet or circular holes thereon for drawing. A ruler is usually made of plastics or metals and also can be made of cardboard, wood, or bamboo. A tape measure is to measure the lengths of various circumferences and also is very convenient for storage.

Generally, the so-called length measurement apparatus is limited to measure the length according to the fixed graduation unit marked thereon. It is inconvenient for the measurement in various units. Therefore, developing a length measurement apparatus convenient and suitable for measuring in various units is important for the industry.

### SUMMARY OF THE INVENTION

In light of the above background, in order to fulfill the requirements of the industry, the present invention provides a measurement apparatus having a display device.

One object of the present invention is to provide a measurement apparatus having a display device. The measurement graduation unit displayed on the measurement apparatus can be changed by a control unit to fulfill the measurement needs for various length units.

Another object of the present invention is to provide a measurement apparatus having a display device, further comprising a calculating device to provide calculation functionality.

Accordingly, the present invention provides a measurement apparatus having a display device. The measurement apparatus having a display device has the functionality of changing the length measurement unit according to the needs from a user. In addition, according to the design of the invention, the measurement apparatus having a display device further comprises a calculating device to provide the calculation functionality.

### BRIEF DESCRIPTION OF THE DRAWINGS

FIG. 1 is a length measurement apparatus “ruler” in the prior art;

FIG. 2 is a schematic diagram illustrating the measurement apparatus having a display device according to a preferred example of the present invention;

FIG. 3 is a schematic diagram illustrating the measurement apparatus having a display device according to the first preferred example of the present invention;

FIG. 4 is a schematic diagram illustrating the measurement apparatus having a display device according to the second preferred example of the present invention;

FIG. 5A is a schematic diagram illustrating the measurement apparatus having a display device according to the third preferred example of the present invention;

FIG. 5B is a schematic diagram illustrating the measurement apparatus having a display device according to the third preferred example of the present invention;

FIG. 6 is a schematic diagram illustrating the measurement apparatus having a display device according to the fourth preferred example of the present invention; and

FIG. 7 is a schematic diagram illustrating the measurement apparatus having a display device according to the fifth preferred example of the present invention.

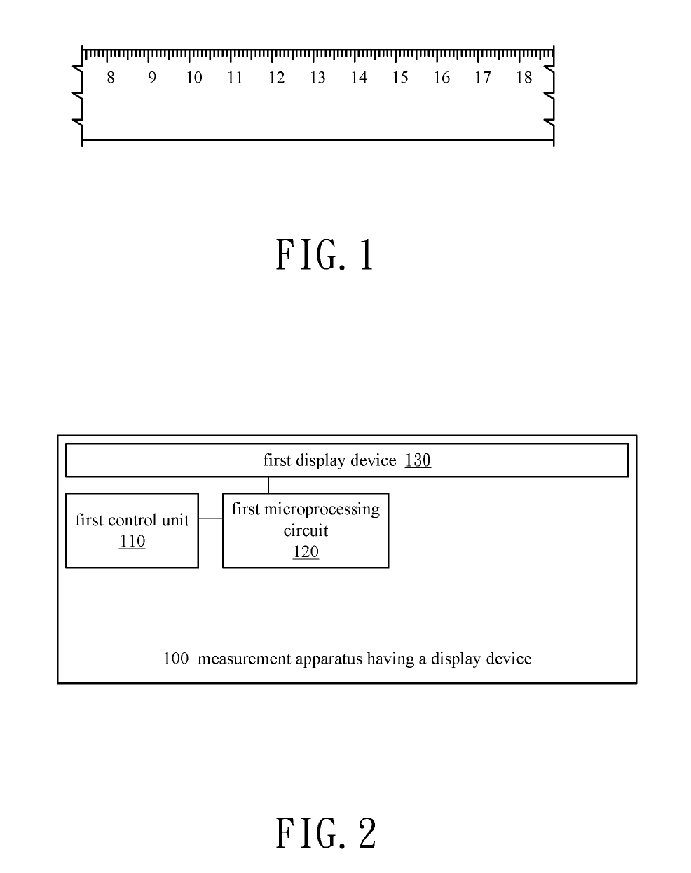

### DESCRIPTION OF THE PREFERRED EMBODIMENTS

What is probed into the invention is a measurement apparatus having a display device. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a preferred embodiment according to the present invention, a measurement apparatus 100 having a display device is disclosed, as shown in FIG. 2. The measurement apparatus 100 comprises a control unit 110, a microprocessing circuit 120, and a display device 130. The first microprocessing circuit 120 is electrically coupled to the first control unit 110. The first control unit 110 is to generate a first signal. The first microprocessing circuit 120 receives the first signal from the first control unit 110 and then generates a second signal. The first display device 130 is electrically coupled to the first microprocessing circuit 120. The first display device 130 generates a third signal after receiving the second signal from the first microprocessing circuit 120. The third signal is shown on the first display device 130 in terms of a measurement scale. The graduation unit of the shown measurement scale can be varied according to the second signal and can be a metric unit, English unit, Taiwanese unit, or other measurement unit known to those who are skilled in the art.

According to a preferred example of this embodiment, the first display device 130 further comprises a protecting layer thereon to prevent the first display device 130 from being scratched or worn by external forces or sharp objects. The protecting layer can be made of high transparent and anti-scratched material. The measurement apparatus having a display device can be made of flexible material or rigid material.

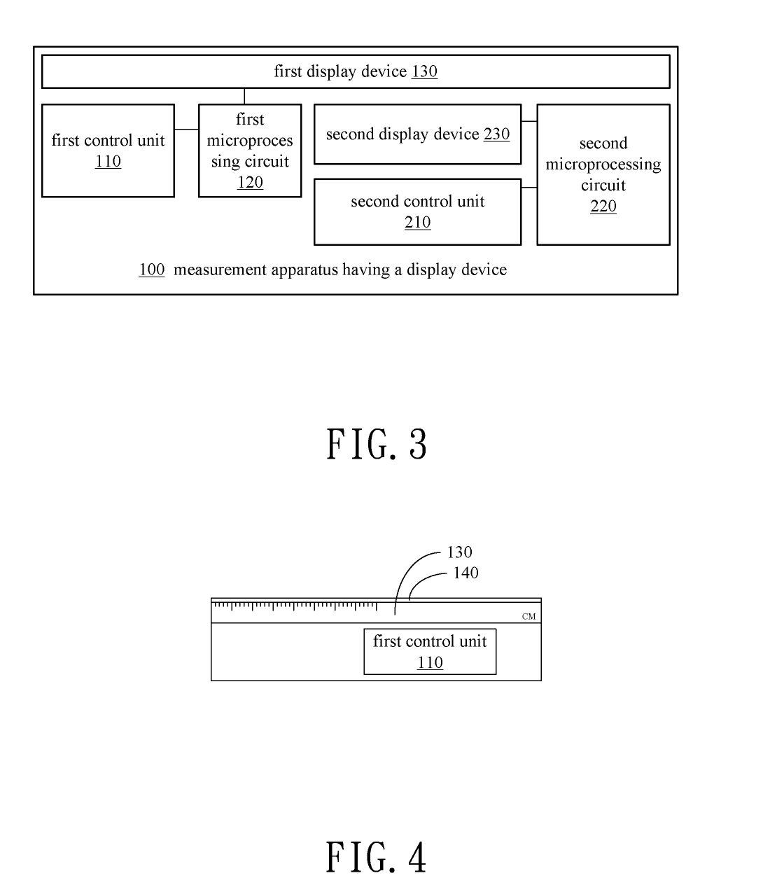

According to a first preferred example of this embodiment, the measurement apparatus having a display device further comprises a calculating device, as shown in FIG. 3. The calculating device comprises a second control unit 210, a second microprocessing circuit 220, and a second display device 230. The second microprocessing circuit 220 is electrically coupled to the second control unit 210. The second control unit 210 is to generate a fourth signal. The second microprocessing circuit 220 receives the fourth signal from the second control unit 210 and then generates a fifth signal. The second display device 230 is electrically coupled to the second microprocessing circuit 220. The second display device 230 generates a sixth signal after receiving the fifth signal from the second microprocessing circuit 220. The sixth signal can be shown on the second display device 230 in terms of numbers and operational notations.

The measurement apparatus having a display device can further comprise a first power supply unit and a second power supply unit, not shown in the figure. The first power supply unit is used to provide electrical power for the measurement apparatus. According to an example of the invention, the first power supply unit can be electrically coupled to the first microprocessing circuit 120. By controlling the on/off state of the first power supply unit by the first control unit 110, supplying electrical power to the first microprocessing circuit 120 can thus be controlled. The second power supply unit can be electrically coupled to the second microprocessing circuit 220. By controlling the on/off state of the second power supply unit by the second control unit 210, supplying electrical power to the second microprocessing circuit 220 can thus be controlled. The first power supply unit and the second power supply unit can be batteries, transformers, or solar cells. According to a preferred example of the invention, the two power supply units can be designed to be a combination of the above two or more than two types, such as a combination of batteries and solar cells, automatically or manually switched between the two modes. According to another preferred example of the invention, the first power supply unit and the second power supply unit can be the same power supply unit. In other words, according to the embodiment, the same power supply unit can be used to supple electrical power to the first microprocessing circuit 120 and the second microprocessing circuit 220.

According to this embodiment, the first display device 130 and the second display device 230 can be liquid crystal displays (LCDs), light emitting diode displays (LEDs), organic light emitting diode displays (OLEDs), or other displays known to those who are skilled in the art.

According the second preferred example of this embodiment, the top edge of the first display device 130 of the measurement apparatus can have a rigid portion 140, as shown in FIG. 4. The rigid portion 140 can strengthen the measurement apparatus to prevent the apparatus from wear or scratch by hard objects like pens and knives.

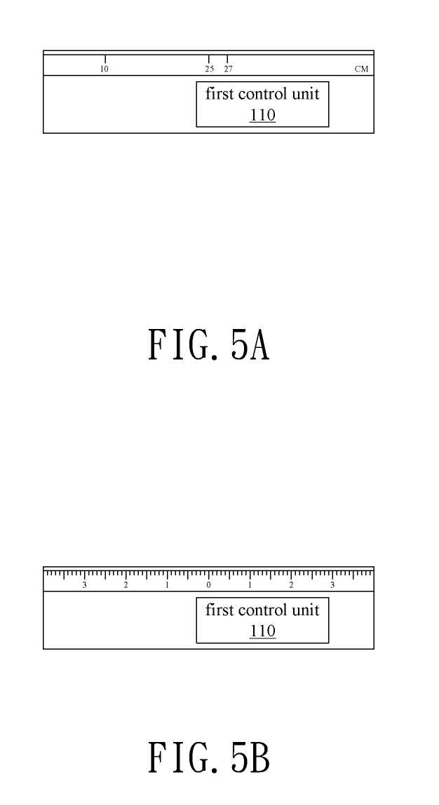

According the third preferred example of this embodiment, in the measurement apparatus, the first display device 130 can display the minimum differentiated graduation required by the user according to the user's need. The minimum differentiated graduation is considered to be the minimum accurate graduation unit, as shown in FIGS. 5A and 5B.

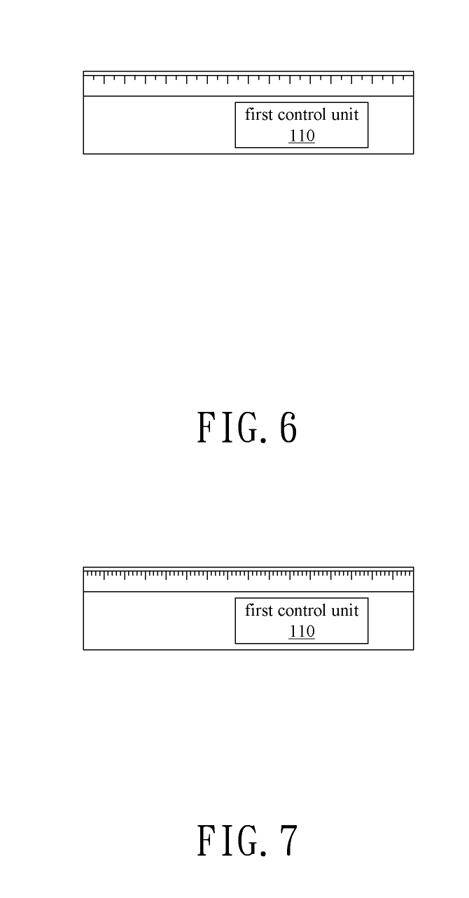

According the fourth preferred example of this embodiment, the measurement apparatus having a display device further comprises an internal access memory device. A plurality of sets of values can be inputted by the first control unit 110 into the measurement apparatus and be transformed to a plurality of sets of specific dimensions displayed on the first display device 130. The plurality of sets of specific dimensions are the common used dimensions or the special dimensions requested by the user. The special dimensions can be saved in the internal access memory device and can be accessed by the user easily to be retrieved on the first display device 130, as shown in FIG. 6.

According the fifth preferred example of this embodiment, the first display device 130 of the measurement apparatus has the reference point appeared on any position of the displayed graduation according to the user's need so as to display the relative graduation corresponding to the left and the right hand sides of the reference point, as shown in FIG. 7. During drawing, as a user wants to measure or mark points corresponding to the two sides of a specific point, the user can set the reference point at a proper position and then can easily proceed with his task, according to the design of this embodiment. Compared to the measurement apparatus in the prior art, in which the reference point is always positioned at one end of the apparatus, the user has to calculate the relative dimensions corresponding to the two sides of a specific point by himself. In other words, the design of this embodiment provides a convenient choice for users.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A measurement apparatus having a display device, comprising:
a first control unit for generating a first signal;
a first microprocessing circuit electrically coupled to said first control unit for generating a second signal after receiving said first signal from said first control unit; and
a first display device electrically coupled to said first microprocessing circuit for generating a third signal after receiving said second signal from said first microprocessing circuit and then displaying said third signal thereon in terms of a measurement scale.

2. The apparatus according to claim 1, further comprising a calculating device wherein said calculating device comprises:
a second control unit for generating a fourth signal;
a second microprocessing circuit electrically coupled to said second control unit for generating a fifth signal after receiving said fourth signal from said second control unit; and
a second display device electrically coupled to said second microprocessing circuit for generating a sixth signal after receiving said fifth signal from said second microprocessing circuit and then displaying said sixth signal thereon in terms of numbers and operational notations.

3. The apparatus according to claim 1, further comprising a power supply unit to supply electrical power to said apparatus.

4. The apparatus according to claim 1, wherein said first display device is a liquid crystal display (LCD).

5. The apparatus according to claim 1, wherein said first display device is an organic light emitting diode (OLED) display.
